(19) United States
(12) Patent Application Publication
(10) Pub. No.: US 2010/0079426 A1
(43) Pub. Date: Apr. 1, 2010

(54) SPATIAL AMBIENT LIGHT PROFILING

(75) Inventors: Aleksandar Pance, Saratoga, CA (US); David Robbins Falkenburg, San Jose, CA (US)

Correspondence Address: DORSEY & WHITNEY LLP;on behalf of APPLE, INC., 370 SEVENTEENTH ST., SUITE 4700, DENVER, CO, 80202-5647, US

(73) Assignee: Apple Inc., Cupertino, CA (US)

(21) Appl. No.: 12/238,533

(22) Filed: Sep. 26, 2008

(51) Int. Cl. G09G 5/00

(52) U.S. Cl. 345/207

(57) ABSTRACT

A method for applying user experience effects to a displayed image. The method may sample data from sensors and create a profile based on the sampled data. The method may use the profile to alter the displayed image to reflect the environment of a computing system.

### FIELD OF THE INVENTION

The present invention generally relates to displaying images on computing systems and, more specifically, to altering a displayed image based on an ambient light profile.

### BACKGROUND

Computers may be used for shopping, working or homework and may be used in a variety of environments. The lighting in the environments may vary from natural sunlight to fluorescent lighting in a room with no windows. Accordingly, ease of viewing an associated computer display may vary with lighting conditions. Currently, it is possible to increase the brightness of the display to compensate for bright ambient light. For example, a user may increase the brightness of the screen when outside in bright sunlight. Even though the brightness of the screen may be adjusted, it may still be difficult for the user to view the screen, because ambient light may be much brighter than even the maximum brightness of a display screen, leading to lowered contrast of the screen.

Additionally, the user may simply prefer to change the appearance of the screen for visual stimulation. Generally, a user may change the appearance of the computer's desktop or may employ software to vary the appearance of the display screen. However, most current methods of varying the appearance of a display screen does not reflect or account for the environment in which the computer may be located. Varying the appearance of a display based on the location of the associated computer is desirable. Accordingly, there is a need in the art for an improved method of altering a displayed image.

### SUMMARY

One embodiment of the present invention takes the form of a method for changing an image on a computing system. Measurement devices may measure light data and a processing unit may receive the data from the measurement devices. The processing unit may create a spatial ambient light profile based on at least the received data and an image displayed on a computing system may be altered in accordance with the spatial ambient light profile. The direction of a light source may be determined from the light data and effects may be applied to the image displayed on the computing system to simulate the environmental lighting conditions. Further, the image may be altered by shading the image to simulate the effect of the light source on the image. The light data may also be used to reflect the time of day in the image displayed on the computing system. The light data may also be used to determine the predominant wavelength of a light source and an image may be altered by applying a color profile that may be based at least on the predominant wavelength of the light source. Additionally, data noise may be filtered out of the measurements by periodically sampling the sensor data. Moreover, the image may be altered by applying effects to images selected by a user and/or by applying contrast grading to the image.

In another embodiment, the present invention may take the form of a method for altering an image based on an environment. Light intensity sensors may measure ambient light and periodically sample the measurements provided by the light intensity sensors. The light intensity sensors may provide the ambient light data to a computing system and processors in or connected to the computing system may create a light profile based on at least the measurements provided by the light intensity sensors. Effects may be applied to an image displayed on the computing system, wherein the effects are based at least on the light profile. The ambient light measurements may be used to determine the direction of a light source and shading may be applied to the image to simulate the effect of the light source on the image. The light intensity sensors may also provide data used to determine the predominant wavelength of a light source and an image may be altered by applying a color profile based on at least the predominant wavelength of a light source. Additionally, data noise may be filtered from the sensors measurements by periodically sampling the sensor data. Furthermore, the images may be altered by applying effects to images selected by a user and/or by applying contrast grading to the image.

These and other advantages and features of the present invention will become apparent to those of ordinary skill in the art upon reading this disclosure in its entirety.

### BRIEF DESCRIPTION OF THE DRAWINGS

FIG. 1A shows a general system and an example of how the data may flow between elements within the system.

FIG. 1B shows a general block diagram that depicts one embodiment of a data flow process.

FIG. 1C shows an embodiment of a portable computing system with multiple sensors located on the display casing of the portable computing system.

FIG. 1D shows another embodiment of a portable computing system with multiple sensors located on the casing.

FIG. 1E shows yet another embodiment of a portable computing system with multiple sensors located on the display casing.

FIG. 1F shows yet another embodiment of a portable computing system with multiple sensors located on the back of the portable computing system.

FIG. 2A shows an example of a computing system with multiple sensors located on the display casing.

FIG. 2B shows an example of a computing system with multiple sensors located on the processor casing.

FIG. 2C shows yet another example of a computing system with multiple sensors located on the keyboard and also remote sensors not located on the computing system.

FIG. 3A shows an example of an altered image in which the image may be dynamically altered depending on at least the location of a light source.

FIG. 3B shows an example of an altered image in which the image may be dynamically altered depending on at least the location of a light source.

FIG. 3C shows another example of an altered image in which the image may be dynamically altered depending on at least the location of a light source.

FIG. 3D shows an example of a window in which the appearance of the window may be dynamically altered depending on at least the location of a light source.

FIG. 3E shows another example of a window in which the appearance of the window may be dynamically altered depending on at least the location of a light source.

FIG. 4 shows another example of the sensor locations on a computing system.

FIG. 5 is a flowchart depicting operations of an embodiment for altering an image based on spatial ambient light profiling.

### DETAILED DESCRIPTION OF EMBODIMENTS

Generally, one embodiment of the present invention may take the form of a method for changing a user experience by altering certain aspects or features of displayed images on a computing system. Continuing the description of this embodiment, sensors may be located on the computing system and may provide data such as the lighting conditions of the environment. The lighting data may be used to create an ambient light profile. The ambient light profile may be used to apply altered user experience effects to the displayed image. The effects may alter the image so that the image reflects the environment of the computing system. For example, shading may be applied to images and/or windows on the monitor based on at least the location of the light source in the environment.

Another embodiment may take the form of a method for altering an image on a computer to account for environmental conditions. In this embodiment, the computing system may receive data describing the environment of the computing system from one or more sensors. The data may be periodically sampled and used to determine how the image may be altered to reflect environmental changes. For example, characteristics of a lighting source may be determined by processing the sensor data and differing color profiles may be loaded or used to account for such characteristics. Sample characteristics may include, but are not limited to, light temperature, light color intensity, the direction/location of the light source with respect to the computer and so on.

It should be noted that embodiments of the present invention may be used in a variety of optical systems and image processing systems. The embodiment may include or work with a variety of optical components, images, sensors, cameras and electrical devices. Aspects of the present invention may be used with practically any apparatus related to optical and electrical devices, optical systems, presentation systems or any apparatus that may contain any type of optical system. Accordingly, embodiments of the present invention may be employed in computers, optical systems, devices used in visual presentations and peripherals and so on.

Before explaining the disclosed embodiments in detail, it is to be understood that the invention is not limited in its application to the details of the particular arrangements shown, because the invention is capable of other embodiments. Moreover, aspects of the invention may be set forth in different combinations and arrangements to define inventions unique in their own right. Also, the terminology used herein is for the purpose of description and not of limitation.

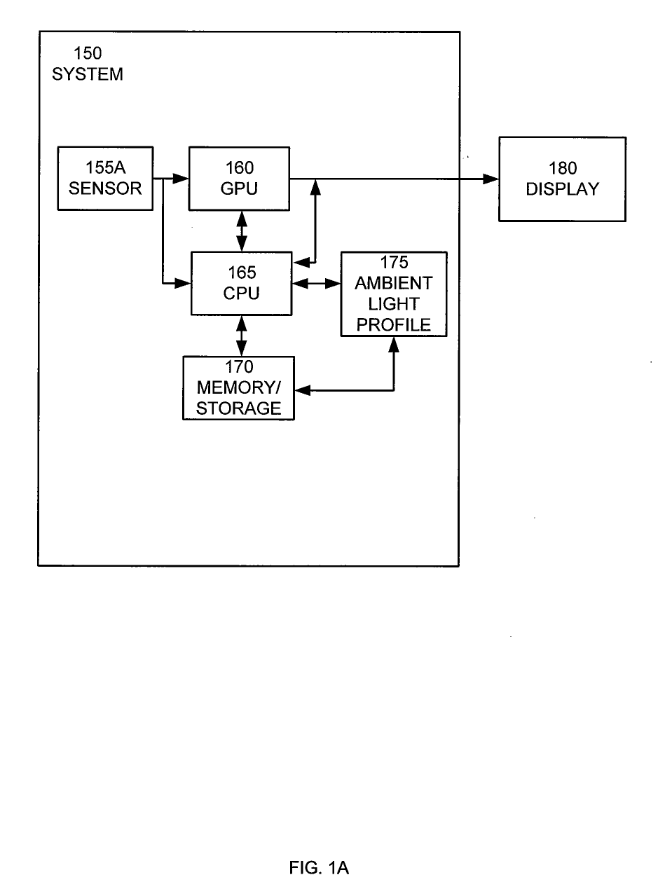

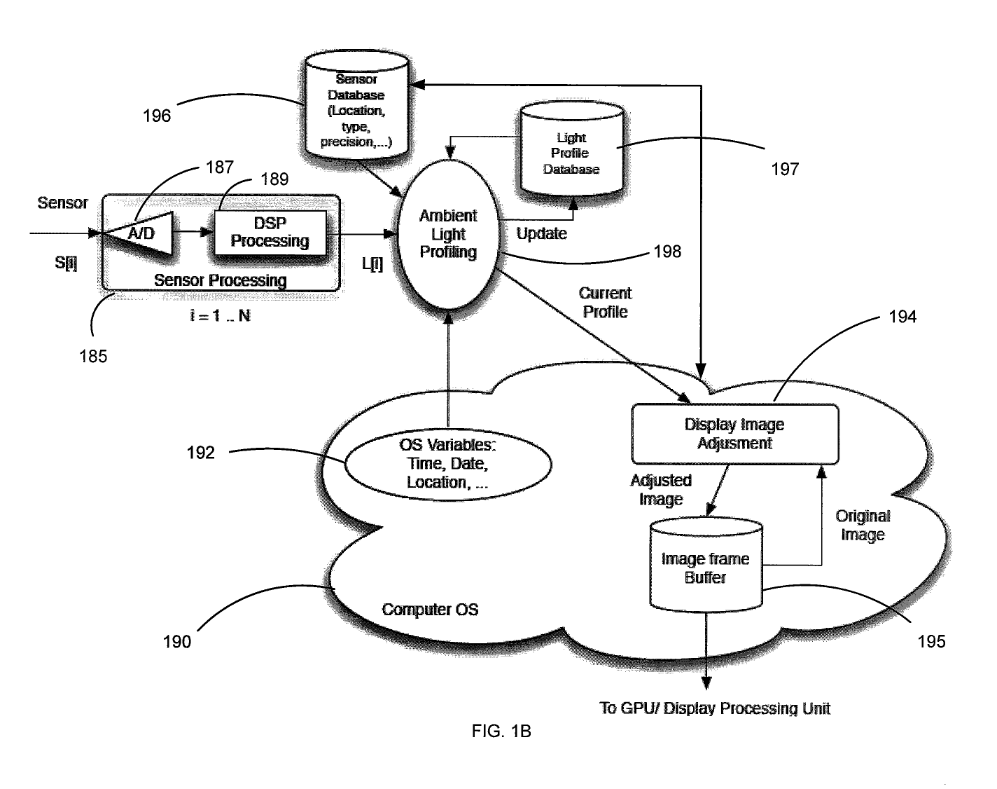

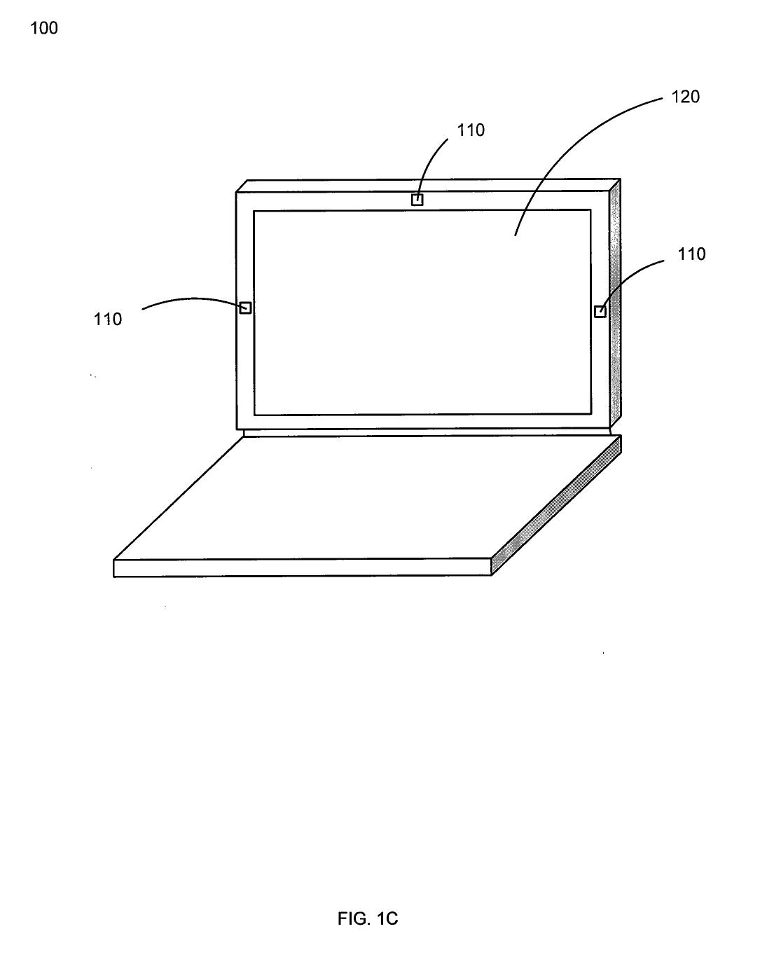

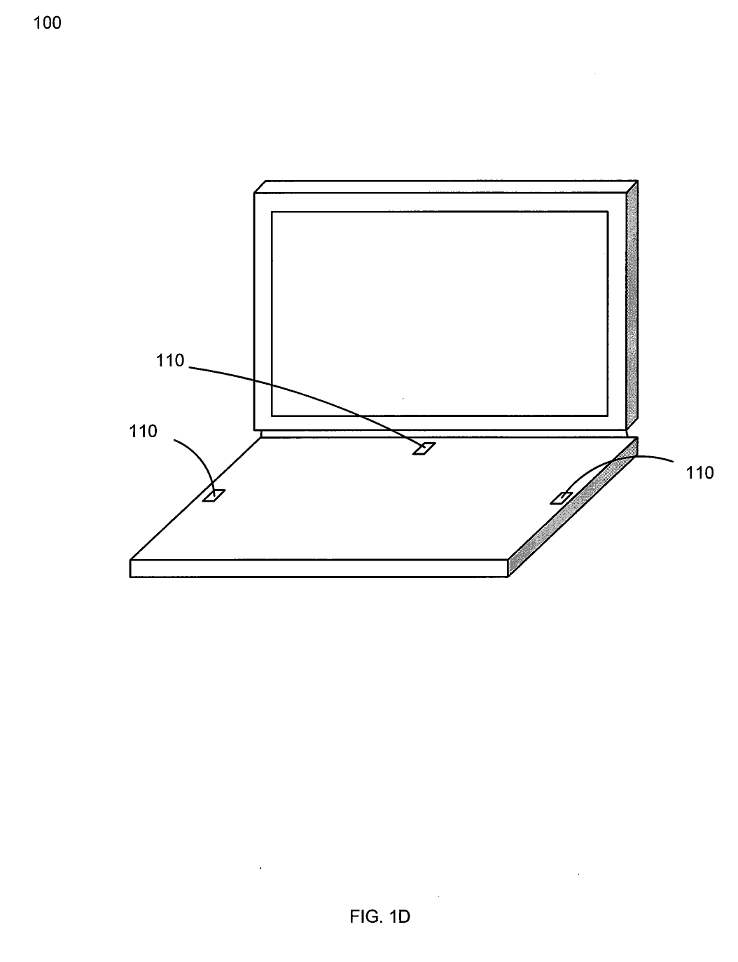

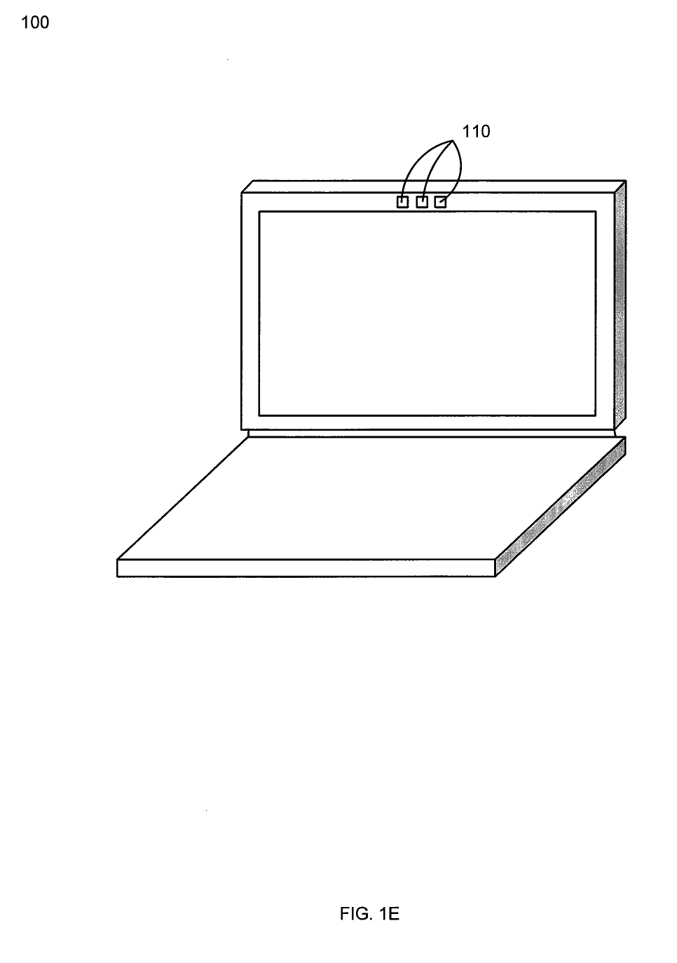

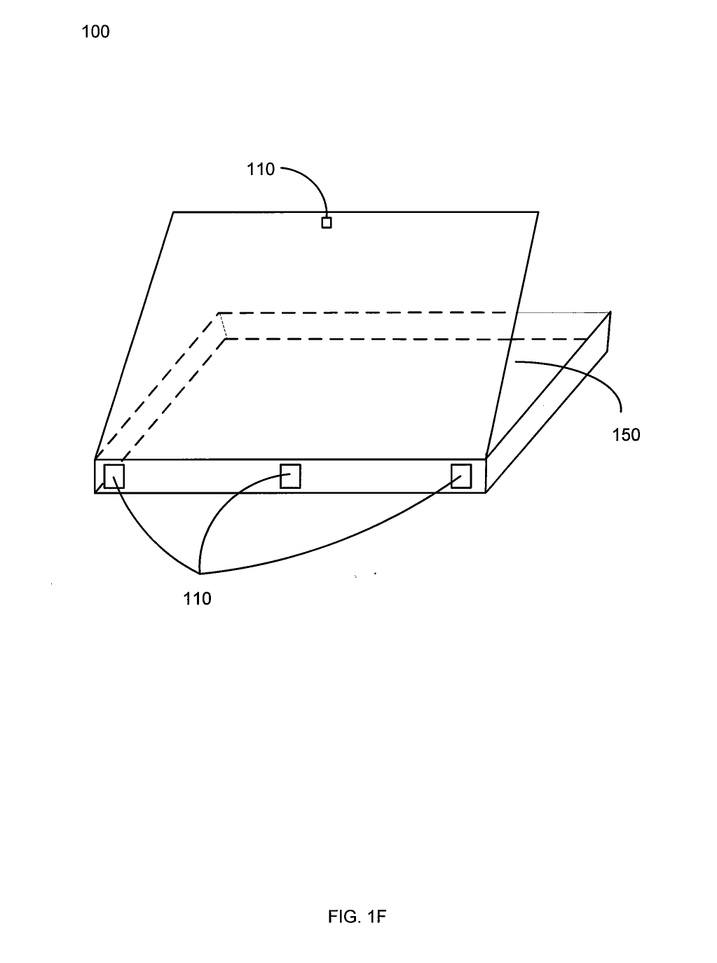

FIG. 1A shows a general system 150 and the an example of how the data may flow to, and/or between elements within the system. In system 150, at least one sensor 155 may provide data to a graphical processing unit 160 and/or a central processing unit 165. The data may include, but is not limited to, light intensity data, frequency/wavelength data, and so on. The terms “wavelength” and “frequency” may be used interchangeably herein. The sensors may be connected to a bridge block (not shown in FIG. 1A) which may be connected to the graphical processing unit 160 and/or the central processing unit 165. Further, some systems may not include both the graphical processing unit and the central processing unit.

Generally, the graphical processing unit 160 may receive the data from the sensor 155 or the bridge block as previously mentioned, the graphical processing unit may process the data and then provide the processed data to the central processing unit 165. The graphical processing unit 160 may also receive the data from the sensor 155 and pass the data to the central processing unit 165 without first processing the data. The graphical processing unit and/or the central processing unit 165 may process the data and create at least an ambient light profile 175 which may be passed to the memory/storage 170. The ambient light profile will be discussed in further detail below. The central processing unit may provide the data to memory/storage 170 in the system 100. The memory/storage 170 may be a hard drive, random access memory (“RAM”), cache and so on. The memory/storage 170 may store the ambient light profile 175. The graphical processing unit 160 may process the data from the sensor 155 and provide the processed data to the display 180. Additionally, the central processing unit 165 may provide the processed data to the display 180.

FIG. 1B shows a block diagram that depicts the data processing flow. In FIG. 1B, the raw sensor data S[i] may be provided by the sensor to a system 185 for processing. In one embodiment, the raw sensor data may be analog data and may be received by an analog to digital converter 187. The analog to digital converter 187 may convert the analog data to digital data. The data may pass from the analog to digital converter 187 to a digital signal processor 189. The digital signal processor may process the digital data and pass the data to an ambient light profiling system 198 that may create an ambient light profile. The ambient light profiling system 198 may also receive inputs from at least one of a sensor database 196, a light profile database 197 and a computer operating system 190. The sensor database 196 may include information such as the location, type, precision and so on, and may receive data from the computer operating system 190 such as operating system variables including the date, time and location. The light profile database 197 may be updated by the ambient light profiling system 198 and may also provide data to the ambient light profiling system. The ambient light profile may be based on sensor data as well as information such as the location, type and precision of the sensors as well as information such as the current time, date and location of the system.

The computer operating system 190 of FIG. 1B may include data such as the operating system variables 192. The operating system variables 192 may be stored in memory, cache, buffers and so on. Additionally, the operating system variables 192 may include information such as the current time, current date, the location of the system and so on. Furthermore, the computer operating system 190 may receive the ambient light profile at a display image adjustment system 194. The display image adjustment system 194 may be provided with the original image from the image frame buffer 195, adjust the original image to provide an adjusted image for display and then pass the data for the adjusted image back to the image frame buffer 195. The image frame buffer 195 may then pass the data to the graphical processing unit and/or the display processing unit.

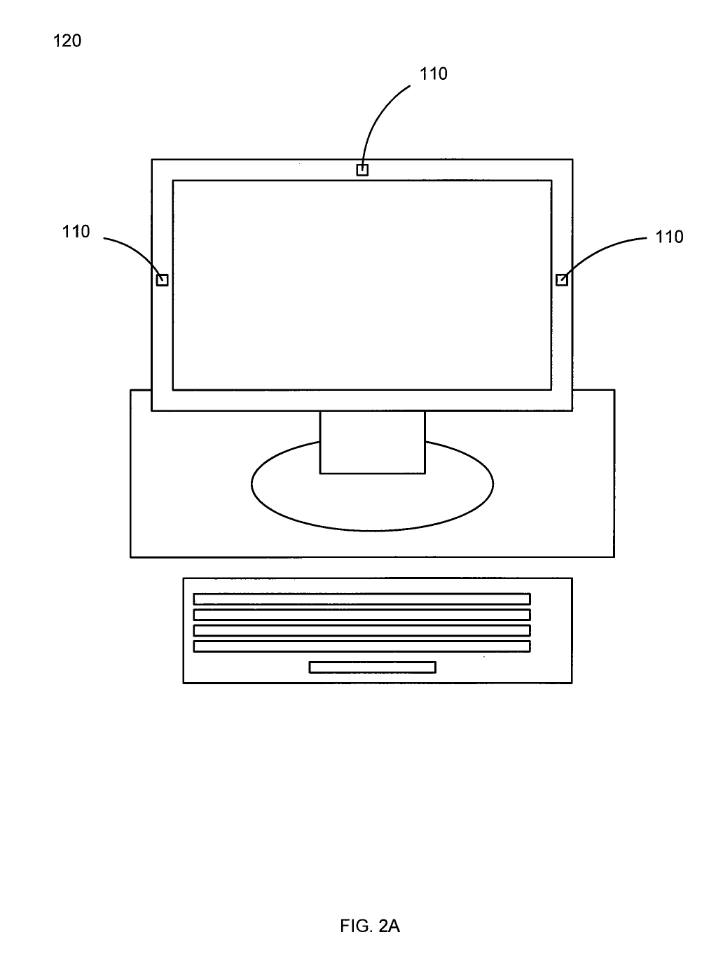

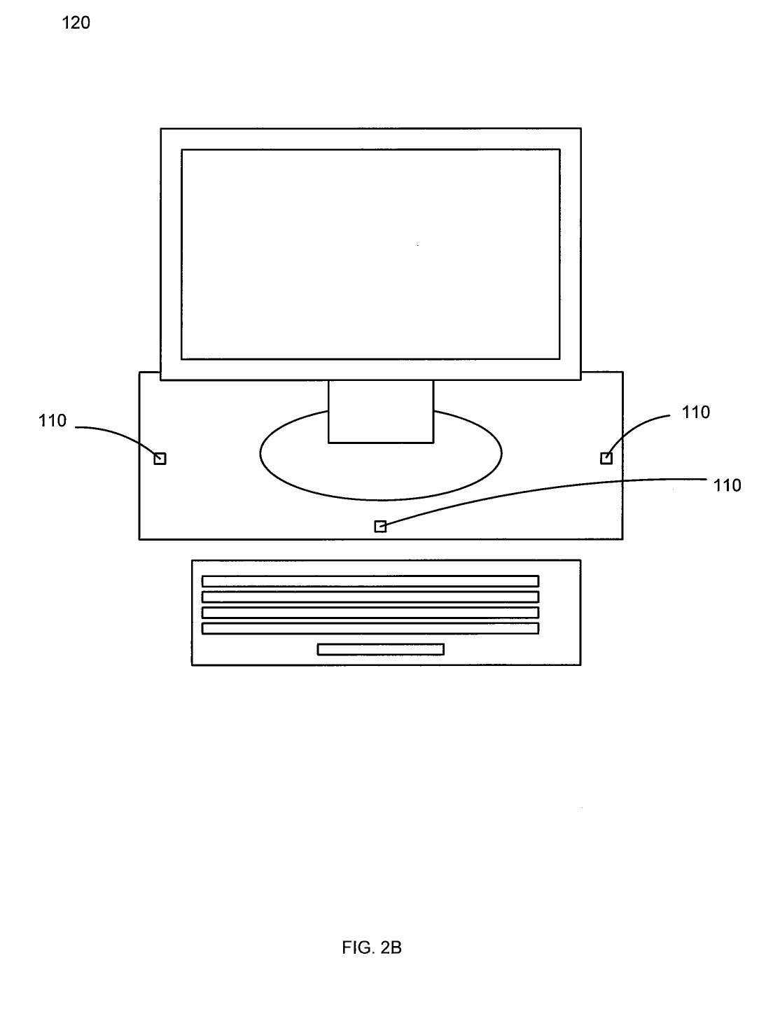

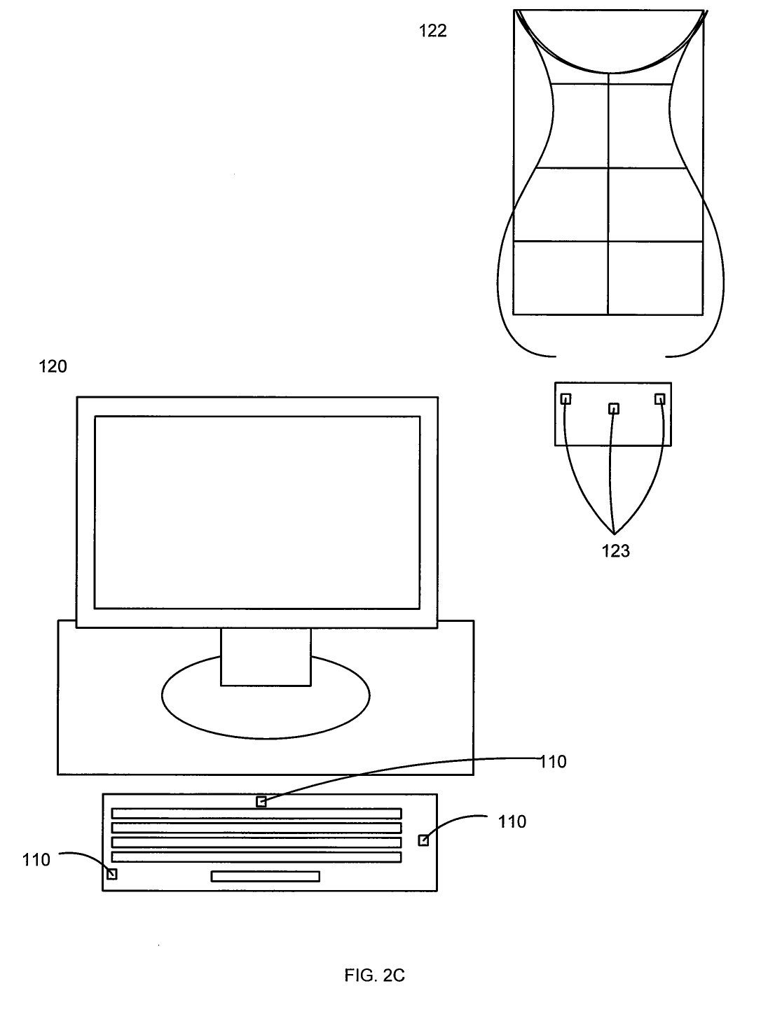

FIG. 1C shows an embodiment of a portable computing system 100 having multiple integrated sensors 110. The sensors may provide data to the computing system so that a displayed image may be altered to reflect characteristics of the environment where the computing system is located. Generally the computing system may be any type of processing system including the portable computing system 100 shown in FIG. 1C or a desktop computing system as shown in FIG. 2A. A computing system may include any number of elements such as, but not limited to, a display 120, a casing, a central processing unit, a graphical processing unit, a keyboard and so forth. The sensors 110 may be located in a number of positions on the portable computing system 100. Additionally, the sensors 110 may also be simultaneously located at various places on the portable computing system 100. For example, the sensors may be located on both the display and the casing of the portable computing system 100.

In one embodiment, the sensors may be remotely located from (not attached to) the portable computing system 100. The remote sensors (not shown in FIG. 1C) may communicate with the portable computing system 100 through a wired or wireless communication link. The wireless connection may be an infrared (“IR”) signal, radio frequency (“RF”) signal, wireless Internet Protocol (“IP”) connection, WiMax, combinations thereof or otherwise. The remote sensor may be in a fixed or static location, or may have a dynamic location which may be communicated dynamically by the sensor. The location of the sensor may be determined in a number of ways such as by employing a global positioning system, triangulation or any other suitable process or device. The sensor location database may also be employed in determining the position of the remote sensors.

In one embodiment and as shown in FIG. 1C, the sensors 110 may be located on the display casing of the portable computing system 100. Although three sensors are shown in FIG. 2A, two or more sensors may be employed by certain embodiments. The number of sensors employed may depend on various factors including, but not limited to, the desired granularity of stored ambient light profiles and the effects altering user experience that are desired by the user. The ambient light profile and the altered user experience effects will be discussed in more detail herein. For example, two sensors may be provided on the computing system for basic functionality such as detecting ambient light and altering the contrast of the display accordingly. Furthermore, three or four sensors may be provided on the computing system for extended functionality such as determining a direction of a light source and altering images based on the direction using altered user experience effect such as shading or shadowing. The altered user experience effects may include shading or shadowing, brightness or contrast changes, scene altering, displaying color profile changes and so on.

The sensors 110 may be a number of different types of sensors such as, but not limited to, wavelength (frequency) sensors, light intensity sensors, infrared sensors, and so on. The measurements provided by the sensors 110 may be used by a processor or other element of the embodiment to dynamically alter the appearance of displayed images using, for example, one or more altered user experience effects. Altering images on the display 120 of the portable computing system 100 will be discussed in further detail below.

In some embodiments, the sensors may provide different measurements. As one example, the sensors 110 may provide wavelength/frequency data. The wavelength data may provide information such as: the color of the light in the environment; whether the light is natural or artificial; the type of light source such as fluorescent; or white light or full spectrum, and so on. The wavelength data thus may be used to determine the type of light source and load a different color profile for displaying images on the computing system display 120. The images may be unique elements on the desktop, such as a window of a graphical user interface (“GUI”) or its contents, or may be the desktop itself, for example, the wallpaper.

In another embodiment, the sensors 110 may be light intensity sensors. The light intensity measurements may vary according to the type of light provided in the environment where the portable computing system 100 may be located. For example, the portable computing system may be used in an environment such as, but not limited to: one with no windows and one or more artificial light sources; one with multiple windows; one with one or more windows and one or more artificial light sources; one with no artificial light sources and so on. Additionally, the location of the portable computing system 100 may vary with respect to the one or more light sources. The location of the portable computing system with respect to the one or more light sources, and its impact on operation of the embodiment, will be discussed in further detail below.

The light sensors may be located in various positions on the display casing of the portable computing system 100. For example, as depicted in FIG. 1C, the sensors 110 may be located toward the top, left and right of the display casing. The top position may be referred to herein as “north.” Similarly, the left position may be referred to herein as “west” and the right position may be referred to herein as “east.” Although the sensors 110 are shown in FIG. 1C as centrally located on each of the sides of the display casing, this is done for explanatory purposes only. The sensors 110 may be located at any position along the sides of the display casing. For example, the sensors 110 may be located at the corners of the display casing of the portable computing system 100. Further, the sensors 110 may be located on either the front and/or the back of the display casing of the portable computing system 100. The sensors may be placed so that the measurements taken facilitate determining a location of the light source with respect to the portable computing system 100. For example, the sensors may be placed directly adjacent to one another on the display casing as depicted in FIG. 1E. In this example, the sensors may be exposed to approximately the same light intensity due to the proximity of the sensors to one another. Accordingly, although the type of light may be determined, it may be difficult for the portable computing system to determine whether the light source is located northwest or northeast with respect to the portable computing system because the sensors may report no or minimal lighting differentials between one another. As shown in FIG. 1F, the sensors 110 may also be located on the back of the portable computing system 100. The sensors 110 may be located on the casing of the portable computing system 100 and/or the back of the display casing. Additionally, the sensors 110 may be located on the back of the portable computing system 100 as shown in FIG. 1F and also located on the front of the portable computing system 100 as shown in FIGS. 1C, 1D and 1E.

Additionally, the sensors 110 may provide light intensity measurements. In this embodiment, the sensors 110 may provide measurements that may be used to create or invoke an ambient light profile which may be used to alter the user's viewing experience. For example, images on the display may be altered to reflect the lighting of the environment where the portable computing system is located. Continuing this example, an image may be shaded or cast a shadow to reflect the direction of the light source. The light source may be located above and to the right of the portable computing system 100. Thus, the image may be altered and appear to have a shadow below and to the left of the image displayed on the portable computing system 100. The shading and the alteration of the display image will be discussed in further detail below.

As shown in FIG. 1D, the sensors 110 may be located on the casing of the portable computing system 100. Generally, sensors may detect erroneous data such as a user shadow momentarily cast over a sensor and the data may be used to determine the ambient light profile even though it may not be relevant to determining the location of the light source with respect to the portable computing system. For example, the sensors 110 are on the casing of the portable computing system 100 and a shadow cast by a user while typing may be detected by the sensors and erroneously provided as a lower light intensity, thus affecting the output of the direction of the light source with respect to the portable computing system 100. In one embodiment, a slower data sampling rate may be employed to filter out noise in the data such as a shadow cast by the user. Further, adaptive sampling may be employed to filter out noise in the data. The data sampling will be discussed in further detail below. Although the sensors may be continuously measuring data, the data may be periodically sampled and received by an integrated circuit so that it may be used to alter a displayed image. In one embodiment, the sensor data may be collected from the sensors in analog form and may be converted to digital signals using analog to digital converters. The sensor data may be process and filtered by digital signal processing system hardware and/or software. The processing may include, but is not limited to, adaptive thresholding, fast and/or slow filtering, smoothing and so on. After processing, the processed sensor data may be provided to an ambient light profiling algorithm.

Alternatively, as depicted in FIG. 2A, the sensors 110 may be located on a display of a desktop computing system 120. Additionally, sets of sensors 110, such as an array, may be located in each of the positions on the display of the desktop computing system. Similar to FIGS. 1C and 1D, the sensors 110 may also be located on the computer housing (as in FIG. 2B) and/or or the keyboard (as in FIG. 2C). Insofar as the sensors 110 may be on the keyboard and/or the monitor casing and thus different locations, the measurements provided by the keyboard sensors may be different from the measurements provided by the display sensors. Sometimes, the location of the keyboard may vary depending on the location of the user. In this situation, the keyboard may be positioned at an angle with respect to the monitor casing because the user may be positioned at angle with respect to the plane of the display screen. Accordingly, the sensors may have a dynamic location. The location of the sensors may be determined, stored and dynamically updated in the sensor location database as discussed with respect to FIG. 1C. Similar to FIGS. 1C, 1D, 1E and 1F, the sensors may be located on any portion of the desktop computing system 120 including the back of the computer housing. Additionally, the sensors may be located at multiple positions on the desktop computing system 120 including, the computer housing, the keyboard and the monitor.

As depicted in FIG. 2C, the sensors 110 may be located on the keyboard of the desktop computing system 120. The sensors 110 may be directly connected to the computing system or may be remote sensors. Generally, remote sensors may provide sensor data to the computing system via a wired or wireless signal as opposed to being fixed on the computing system or a part of the computing system such as the keyboard. Further, remote sensors may be located in any number of places such as on another device in the same room, in another room, outside the house and so on. For example, as shown in FIG. 2C, the remote sensors 123 may be located on a box by a window 122. Further, as shown in FIG. 2C, both the remote sensors 123 and sensors 110 may be used to provide data to the computing system.

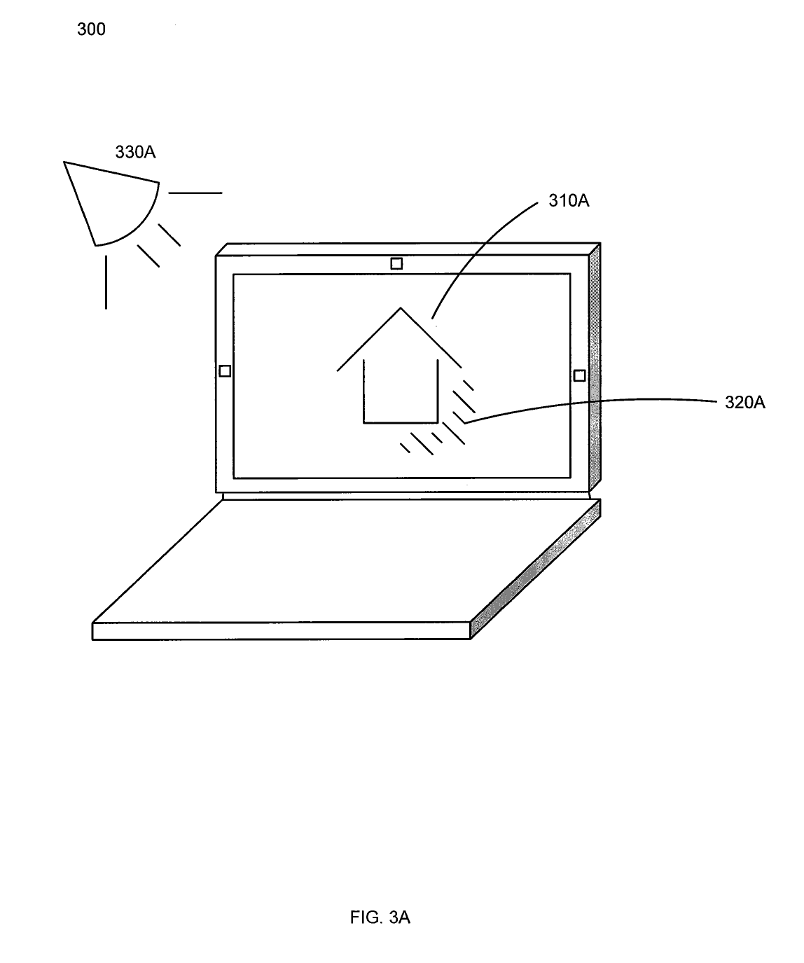

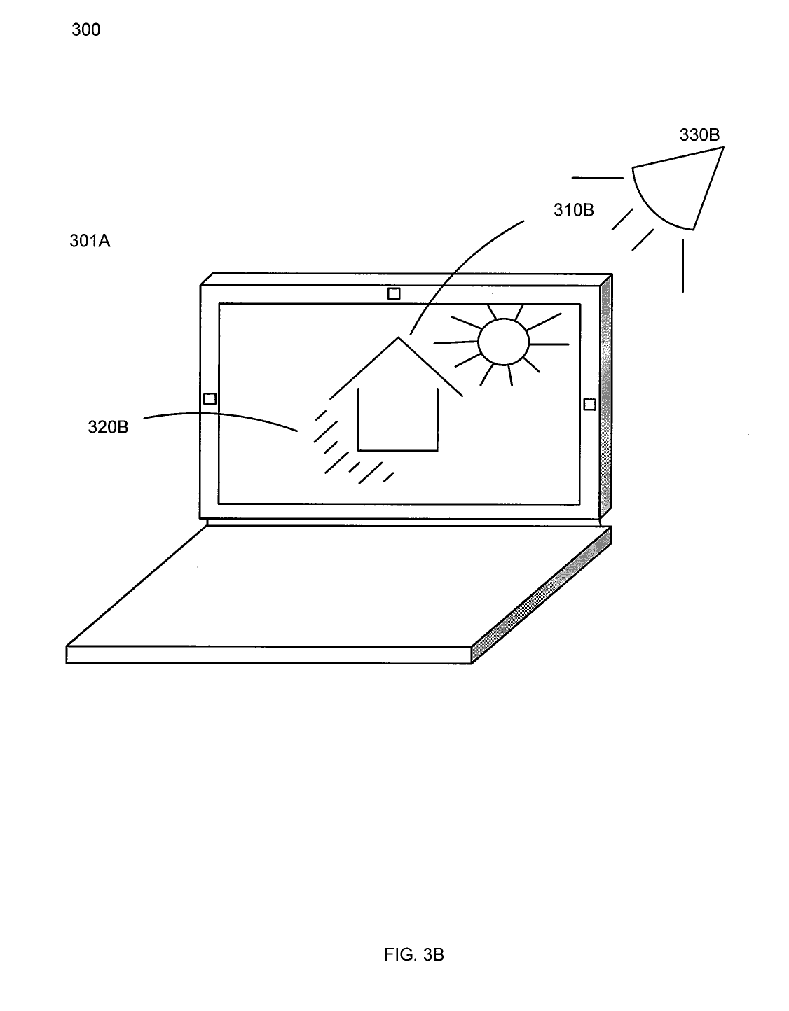

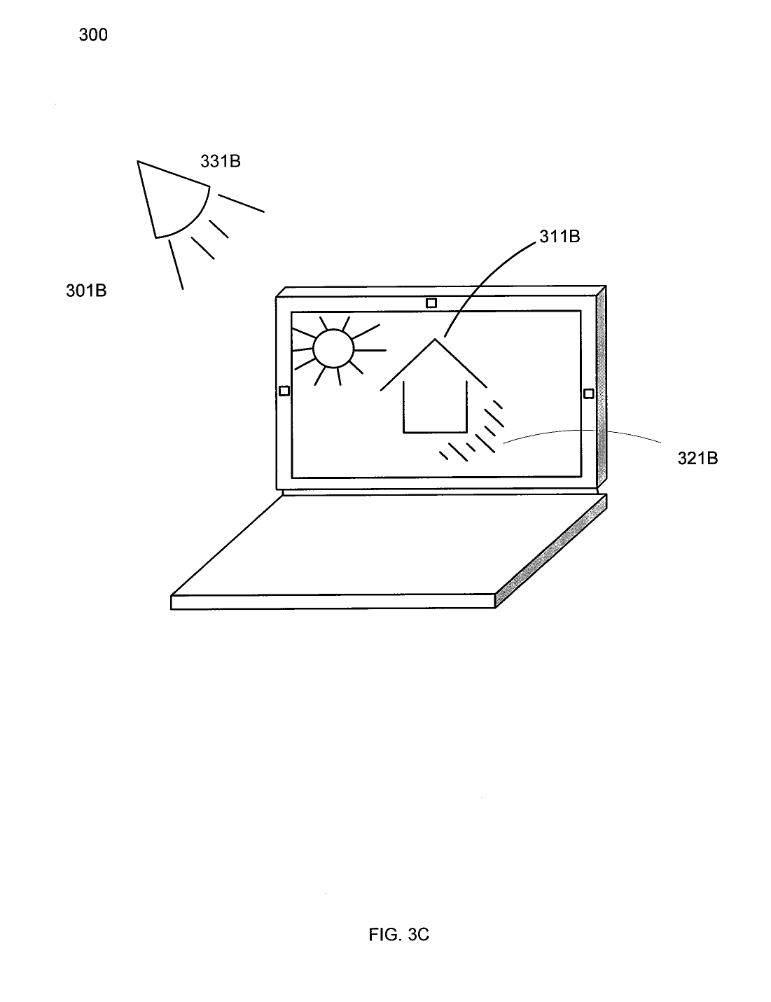

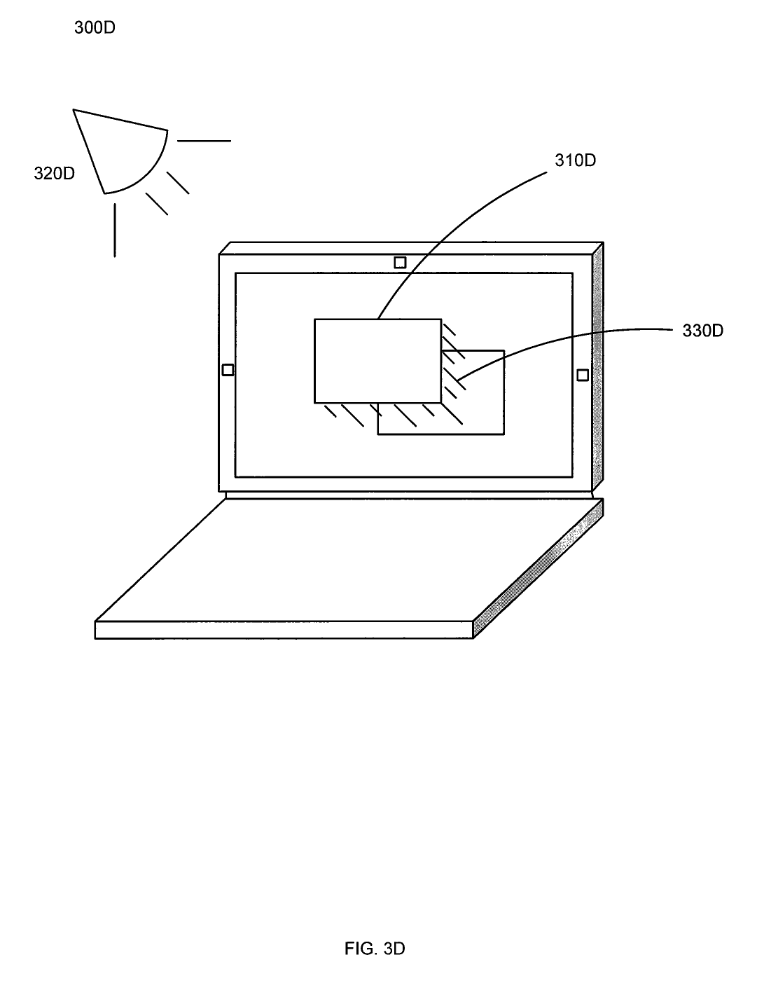

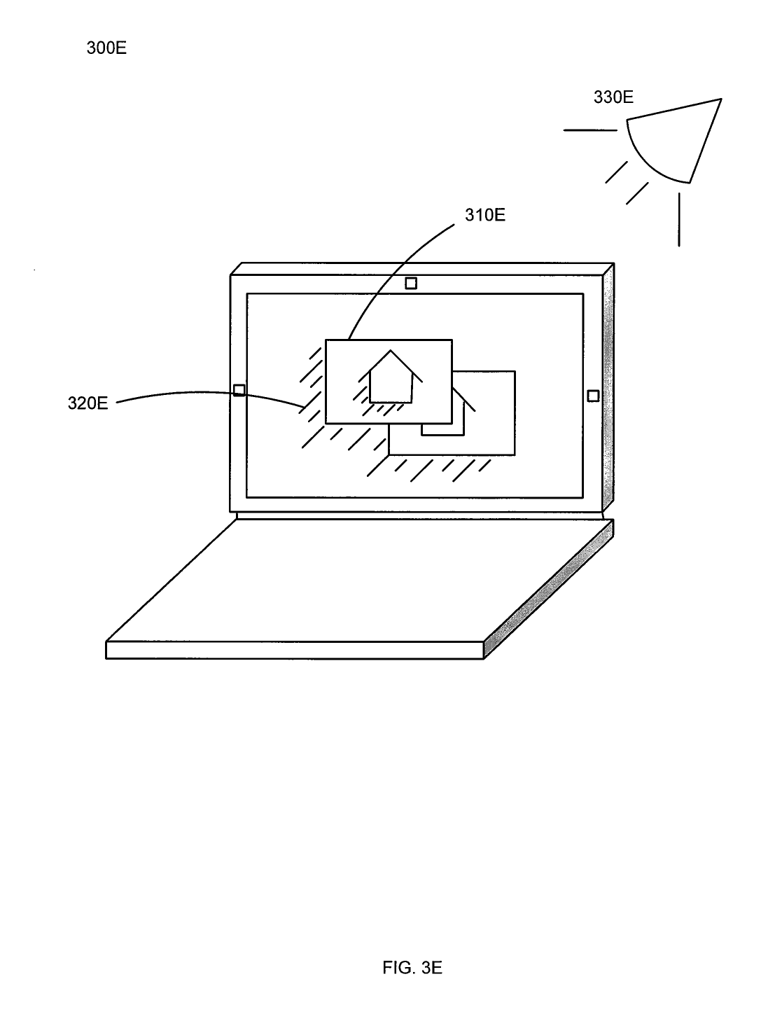

As illustrated in FIGS. 3A, 3B, 3C, 3D and 3E, the altered user experience effects may be applied to a number of different types of images. For example, the effects applied to the images in a computing system may be application specific, applied to any open window on the desktop of the computing system, applied to user specified windows, icons and/or images, and so on. Further, the effects may be applied to the images locally to a single window or part of the screen, or globally to the entire screen and/or any image that may appear on the screen. The user may determine the settings for applying the altered user experience effects to the displayed images. In one embodiment, the altered use experience effects may also be applied to defined parts of the display. In this embodiment, the user may choose to apply the effects to portions of the screen. Thus the effects may be applied to only the images or windows located in the selected part of the display.

The embodiment may employ a number of altered user experience effects. A shading effect may be applied to different images and/or windows displayed based on the direction of the light. A contrast grading effect may be varied across a window, desktop or complete screen accounting for the direction of the light for ease of viewing. Another altered user experience effect may include changing the brightness of the display based on a sensed intensity of ambient light. The user may desire to vary the brightness of the display in a number of circumstances such as when the light source is behind the user and, thus, shining directly on the screen of the computing system, or when the light source is behind the display and so on. In another embodiment, the option of which image adjustments to apply to and to which portion of the screen (or the entire screen) may be selected and/or configured by the user, or the operating system may make the determination based on a number of factors such as, current display context, the executing application, which application is in the foreground window, history of user selections and so on. For example, an image application may be in the foreground window, thus the operating system may apply image adjustments and/or effects to each image displayed inside the application windows.

Another altered user experience effect may include switching the display from a day view to a night view. For example, the altered user experience may include loading a series of background images. Each of the background images may be the same scene but rendered differently depending on a number of factors, including but not limited to, the light source direction, intensity of the image and so on. Additionally, each of the background images may be depict at least a morning scene, noon scene, afternoon scene, evening scene and night scene of the same image. Furthermore, it may be possible to determine the ambient light white point temperature or to determine the type of light and provide a color profile that may match the ambient light. Generally, the white point temperature may be a set of chromaticity coordinates that may define the color “white.” Chromaticity refers to the quality of a color based on at least its dominant wavelength and purity.

FIG. 3A shows an example of a portable computing system 300 displaying an altered image 310A. In this example, an image displayed in a window may be altered by applying an effect such as shading to change the user's viewing experience. As illustrated in FIG. 3A, the shading 320A may simulate the displayed image being affected by, or interacting with, the light source 330A in the environment. The direction of the shading 320A of the displayed image may vary with the location of the light source 330A in the environment. As shown in FIG. 3A, the light source 330A may be located northwest of the portable computing system display. Accordingly, the altered image 310A may appear with shading 320A southeast of the image. The shading effect may be applied to the displayed image to simulate a three dimensional viewing experience. As another example, the user may select to apply the effects to an application and thus the images displayed in that application may be altered.

FIGS. 3B and 3C illustrate that the displayed image may also be altered to reflect the time of day. In one example, the displayed image may switch from a day view of a scene to a night view of a scene as the ambient light dims. The computing system may determine the time of day based on at least light intensity measurements from the sensors and optionally, time of day information provided by the computing system 300. In another example, the screen of the computing system may vary its contrast as the ambient light dims. That is, as the ambient light dims the screen contrast may be decreased. The altered user experience effect may be applied to the entire desktop or to a window depending on the user's selection. Further, the altered user experience effect may be determined by the operating system.

Additionally, FIGS. 3B and 3C provide two examples, system 301A and system 301B. In system 301A of FIG. 3B, the light source 330B is located approximately northeast of the portable computing system 300. Thus, the altered image 310B may include shading 320B that appears southwest of the image 310B. In system 301B of FIG. 3C, the light source 331B is located approximately northwest of the portable computing system 300. Thus, the altered image 311B may include shading 321B that appears southeast of the image 311B. Further, altering the images may be based on additional information provided by the portable computing system 300 such as the time of day. In one embodiment and as shown in system 301A of FIG. 3B, the sun on the portable computing system 300 may appear in the eastern part of the sky in the morning and as the day progresses. Continuing the embodiment, as shown in system 301B of FIG. 3C, the sun on the portable computing system 300 may appear in the western part of the sky in the afternoon.

In the examples shown in FIGS. 3A, 3B and 3C, the user and/or operating system may have indicated and/or determined a preference to apply the effects only to images that appear in windows specific to an application. Further, the user may have selected that the images should be shaded based on the location of the light source 330B. FIGS. 3A, 3B and 3C use a portable computing system for explanatory purposes only, as the images may be displayed on any type of system including on the display of a desktop computing system.

FIG. 3D shows an example of a portable computing system 300D displaying another altered image 310D. In FIG. 3D, the altered image 310D may be a window on the desktop of the portable computing system 300D. In this example, the light source 320D may be located northwest of the portable computing system 300D. Similar to FIG. 3A, the window 310D may be altered with shading 330D to reflect the location of the light source 320D. Continuing this example, the shading 300D may appear southeast of the image on the desktop because the light source is located northwest of the portable computing system 300D. As illustrated in FIG. 3D, the shading 330D may be applied to the front window and not applied to the back window. Additionally, the shading 330D may be applied to only one window as selected by the user, such as an active window.

In a further example, as illustrated in FIG. 3E, the location of the light source may be northeast with respect to the portable computing system 300E. Accordingly, the shading 330E may appear southwest of the displayed image on the desktop. As shown in FIG. 3E, the shading may be applied to every window displayed on the desktop. Stated differently, the user may select an option to apply shading effects globally to the windows that appear on the desktop. Further, although the user may apply the altered user experience effects to all windows, the user may also choose to apply the effects only to images within, or windows of, an application. For example, in FIG. 3E, both the front and the back window are shaded. However, the image in the front window is shaded and the image in the back window is not shaded.

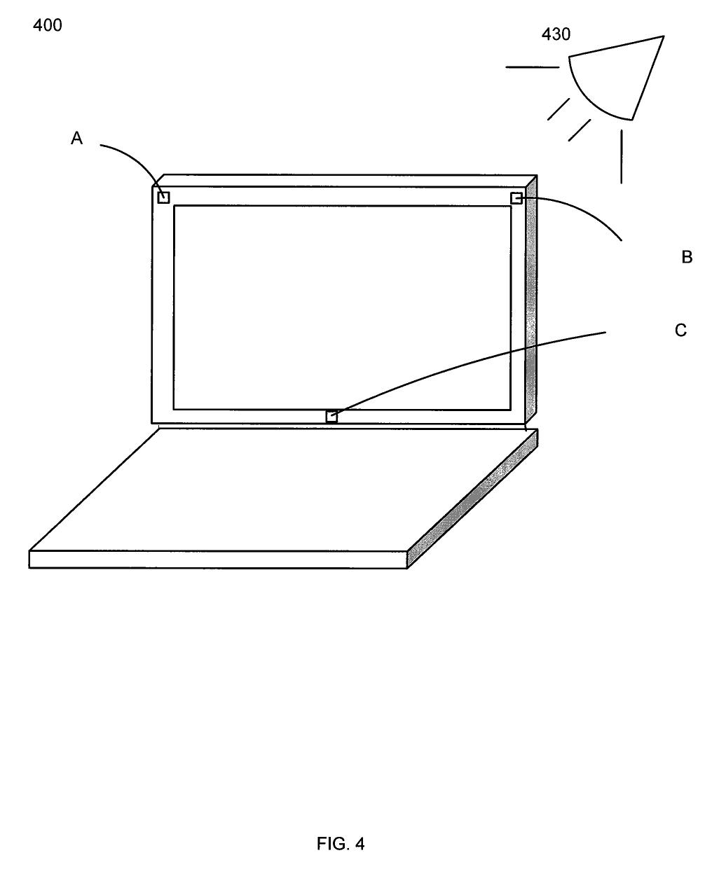

One exemplary manner for determining a light source's position and intensity with respect to a computing system 400 will now be discussed with respect to FIG. 4. In FIG. 4, three depth sensors A, B, C are located on the computing system. Sensor A is located at the top left corner of the display casing or at the northwest corner. Sensor B is located at the at the top right corner of the display casing or at the northeast corner. Sensor C is located at the bottom middle of the display casing or at the south position of the display casing. Additionally, a light source 405 is located northeast with respect to the computing system. Generally, the following set of equations may result from the measurements provided by the sensors, where S(1) is the measurement provided by the sensor A, S(2) may be the measurement provided by the sensor B and S(3) may be measurement provided by the sensor C. Since the light source 430 is closest to sensor B, the following measurements may result for this example:

S(1)<S(2)

S(2)>S(3)

S(1)>S(3)

The sensor measurements may be denoted by the vector:

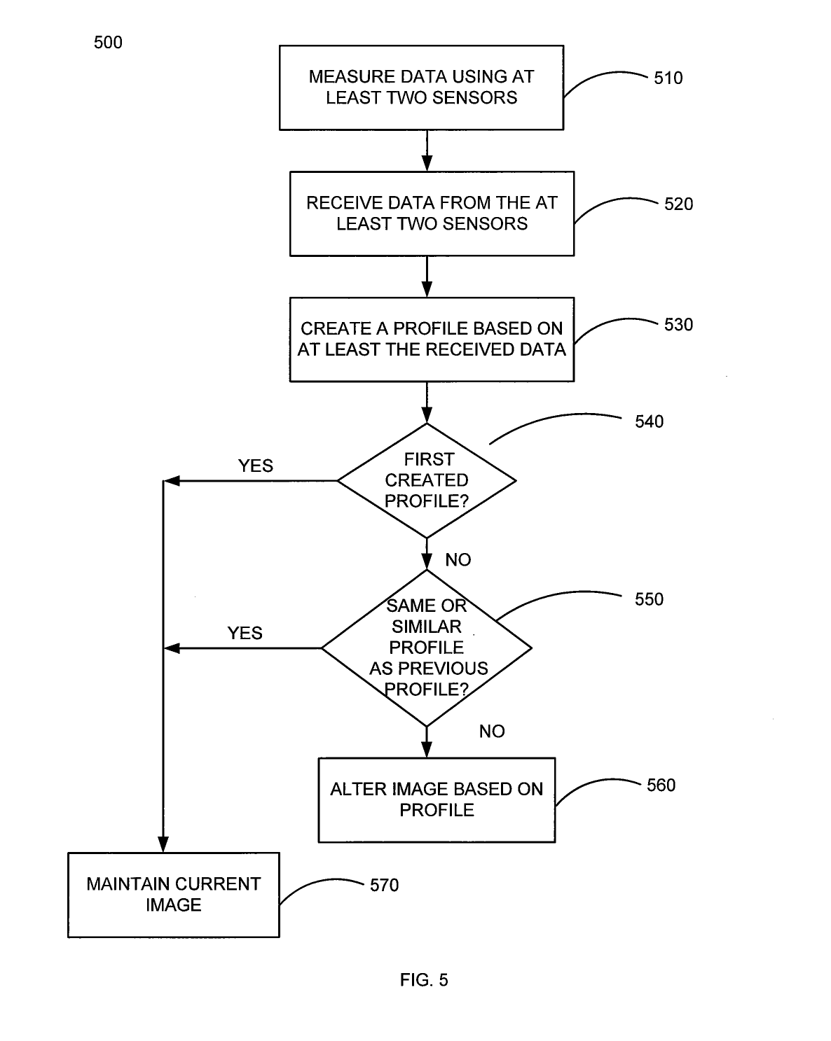

S[1 . . . n]: Sensor Readings

where S(1) may be the sensor reading for the first sensor, S(2) may be the sensor reading for the second sensor and S(n) may be the sensor reading for the nth sensor reading, where n may be the number of sensors. Additionally, the sensor reading may be raw sensor data. The terms “sensor readings” and “sensor measurements” may be used interchangeably herein. The sensors may be at least operationally connected to, or may include an integrated circuit that periodically collects analog input from the sensors. The integrated circuit may then convert the analog input into digital data and provide the digital data to the light profiling software. (Alternately the sensors may be digital.) The light profiling software may perform the operations described herein. Further, the light profiling software may create an ambient light profile, which will be discussed in more detail with respect to FIG. 5. The ambient light profile may also be stored a number of ways such as in memory, cache, buffers, a database and so on.

Further, the light intensity levels for each of the sensor readings may be provided by employing the sensor readings in the following matrix:

L[1 . . . n]: Light Level

where L(1) may be the light level of the first sensor, L(2) may be the light level of the second sensor and L(n) may be the light level of the nth sensor where n may be the number of sensors.

Additionally, the light level L[1 . . . n] may be a function of the sensor readings S[1 . . . n] where i may be a measurement between 1 and n, and the light level may be the processed sensor data.

L[i]=f(S[i])

For example:

L[1]=f(S[1])

where L(1) may be the light level as a function of the measurement of sensor 1.

The light intensity level may be the maximum of the light levels as previously defined:

Intensity Level=MAX(L[i])

Additionally, the ambient level may be provided by employing the following equation:

Ambient Level=SUM(L[i])/n

Further, the ambient level may be a weighted sum average and may accommodate for different factors such as, but not limited to, the location of the sensors, sensitivities of the sensors, speeds of the different sensors and so on.

A matrix may be created using the light levels previously defined:

L[i]=f(S[i])

Δ=matrix {L(i)−L(j)}

Thus, the direction of the light source may be provided:

Direction=f(Δ)

where:

Find <i,j> such that Δ[i,j] is MAX(Δ)

<i,j> mapped into (theta, phi)

The location of the sensors may also be communicated using wired or wireless signals such as an infrared signal.

Additionally, in FIG. 4, the integrated circuit may periodically receive the measurements from the sensors. The image may be altered dynamically using the periodic measurements. The sensors may provide updated “snapshots” of measurements to the operating system. The periodic measurements may prevent continuous updating of the displayed image due to noise. The noise may be light variations that occur for reasons other than the light source changing. For example, noise in the light intensity measurement may be due to a shadow cast by the user over the sensors or another person may walk by the system and momentarily cast a shadow over the sensors. Furthermore, the responsiveness of the system to ambient light changes may be selectable by a user and/or by the operating system. In one example, shadows cast by the user may be rejected by the user selecting low responsiveness or may be detected by selecting high responsiveness. Moreover, learning and adaptive algorithms may be employed to determine what effects are preferred by the user and/or operating system in specific ambient light conditions and specific operating system and application contexts. Stated differently, the algorithms may be able to correlate which effects are preferred by the user and/or operating system with factors such as ambient light conditions, operating system and application contexts.

FIG. 5 is a flowchart generally describing operations of one embodiment of a method 500 for altering displayed images on a computing system screen to affect the viewing experience of a user. In the operation of block 510, sensors that may be located on the computing system may measure data such as light intensity, wavelength of the light, direction of the light and so on. Different sensors may be employed to measure the aforementioned data. For example, wavelength sensors may be employed to measure the wavelength of the light while light intensity sensors may be needed to provide the light intensity and the direction of the light source. Additionally, infrared sensors may be employed to sense infrared reflections which may provide the information to detect the distance of the one or more light sources from the computing system. Further, the location of the sensors may provide the direction of the light source by estimating the differential of the light intensity between the sensors.

In the operation of block 520, the data may be received by the computing system processor. The data may be provided by the sensors located on the computing system. In the operation of block 530, an ambient light profile may be created using at least the data provided by the sensors. The ambient light profile may be a spatial light profile that may include information such as the direction of the light source(s), the type of light provided by the light source (natural, fluorescent, white, full spectrum, and so on), and the intensity of the light source. The ambient light profile may be a set of variables that may be passed onto the software. The software may perform the processing as described with respect to FIG. 4.

At the decision of block 540, the software employed by the method 500 may determine if the ambient light profile is the first ambient light profile created. For example, the determination may be made by checking a buffer that may store previous ambient light profiles. The buffer may be empty, thus indicating that the ambient light profile is the first ambient light profile. In this case, the software employed by the method 500 may proceed to the operation of block 560. In the operation of block 560, the ambient light profile may be used to apply an effect to the displayed image. In the case that the ambient light profile is not the first ambient light profile created, then the method 500 may proceed to the decision of block 550. In the decision of block 550, the ambient light profile may be compared to previous ambient light profiles. The comparison may be performed by comparing the current ambient light profile to a previous ambient light profile that may be stored in the buffer. If the current ambient light profile is the same as the previous ambient light profile, then the method may proceed to the operation of block 570. In the operation of block 570, the current image may be maintained. If the current ambient light profile is different then the previous ambient light profile when compared to each other, the method 500 may proceed to the operation of block 560. In the operation of block 560, the current ambient light profile may be used to alter the displayed image.

Although the present invention has been described with respect to particular apparatuses, configurations, components, systems and methods of operation, it will be appreciated by those of ordinary skill in the art upon reading this disclosure that certain changes or modifications to the embodiments and/or their operations, as described herein, may be made without departing from the spirit or scope of the invention. Accordingly, the proper scope of the invention is defined by the appended claims. The various embodiments, operations, components and configurations disclosed herein are generally exemplary rather than limiting in scope.

1. A method for changing an image on a computing system, comprising:
measuring light data using at least two measurement devices;
receiving data from the at least two measurement devices;
creating a spatial ambient light profile based on at least the received data; and
altering the image displayed on a computing system display in accordance with the spatial ambient light profile.

2. The method of claim 1, wherein measuring light data further comprises measuring environmental lighting conditions.

3. The method of claim 1, further comprising determining the direction of a light source.

4. The method of claim 2, further comprising applying effects to the image displayed on the computing system to simulate the environmental lighting conditions.

5. The method of claim 4, further comprising reflecting a time of day in the image.

6. The method of claim 1, further comprising determining the predominant wavelength of a light source.

7. The method of claim 3, wherein altering the image further comprises shading the image to simulate the effect of the light source on the image.

8. The method of claim 6, wherein altering the image further comprises applying a color profile based on at least the predominant wavelength of the light source.

9. The method of claim 1, further comprising filtering data noise by periodically sampling the sensor data.

10. The method of claim 1, wherein altering the image further comprises applying effects to images selected by at least one of a user or an operating system.

11. The method of claim 10, wherein altering the image further comprises applying contrast grading to the image.

12. A method for altering an image based on an environment, comprising:
measuring ambient light using light intensity sensors;
periodically sampling measurements provided by the light intensity sensors;
providing ambient light data to a computing system;
creating a light profile based on at least the measurements provided by the light intensity sensors; and
applying effects to an image displayed on the computing system, wherein the effects are based at least on the light profile.

13. The method of claim 1, further comprising determining the direction of a light source.

14. The method of claim 12, further comprising applying effects to the image displayed on the computing system to simulate environmental lighting conditions.

15. The method of claim 1, further comprising determining the predominant wavelength of a light source.

16. The method of claim 13, wherein altering the image further comprises shading the image to simulate the effect of the light source on the image.

17. The method of claim 15, wherein altering the image further comprises applying a color profile based on at least the main wavelength of a light source.

18. The method of claim 12, further comprising filtering data noise by periodically sampling the sensor data.

19. The method of claim 12, wherein altering the image further comprises applying effects to images selected by a user.

20. The method of claim 19, wherein altering the image further comprises applying contrast grading to the image.
